(19) United States
(12) Patent Application Publication
(10) Pub. No.: US 2026/0142869 A1
(43) Pub. Date: May 21, 2026

(54) SYSTEMS AND METHODS FOR MACHINE LEARNING DRIVEN ERROR ROOT CAUSE DETECTION AND REMEDIATION

(71) Applicant: Rimo Capital Inc, Las Vegas, NV (US)

(72) Inventor: Samit Halvadia, Glencoe, IL (US)

(21) Appl. No.: 19/386,984

(22) Filed: Nov. 12, 2025

Related U.S. Application Data
(60) Provisional application No. 63/720,863, filed on Nov. 15, 2024.

(51) Int. Cl. H04L 41/0631; H04L 41/0659; H04L 41/16

(52) U.S. Cl. CPC H04L 41/0631; H04L 41/0661; H04L 41/16

(57) ABSTRACT

Systems and methods for determining a root cause of an error and generating recommendations for addressing such are presented. Such a method includes (i) deploying, by one or more processors of a computing device, a trained machine learning model and a trained language model in a client environment; retrieving, via the trained machine learning model, log files associated with the client environment and indicative of one or more errors in the client environment; analyzing, via the trained machine learning model, the log files to determine identifiers indicative of a root cause of the one or more errors in the client environment; embedding the identifiers into an embedding space such that the embedding is indicative of at least one weighted similarity metric of the one or more errors to one or more stored historical errors; and generating, based on the embedding space, a recommendation for the one or more errors.

### CROSS REFERENCE TO RELATED APPLICATIONS

This application claims the benefit of U.S. Provisional Patent Application No. 63/720,863, entitled “SYSTEMS AND METHODS FOR MACHINE LEARNING DRIVEN ERROR ROOT CAUSE DETECTION AND REMEDIATION,” filed Nov. 15, 2024. U.S. Provisional Patent Application No. 63/720,863 is hereby expressly incorporated by reference herein in its entirety.

### FIELD OF TECHNOLOGY

The present disclosure relates to detecting and remediating root causes of errors in a client environment and, more specifically, to techniques for analyzing log files using machine learning models and generating recommendations for responses to errors based on a determined root cause.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

When testing a program or application, testing is conventionally performed in an artificial and/or testing environment, is performed on a backend server, is performed without expert oversight, and/or is performed on a limited number of environments. As such, environment-specific errors can appear and, as such, may be misdiagnosed, have no recommended action, and/or otherwise introduce potential errors into a system. A solution to such is desirable.

### SUMMARY

In some aspects, the techniques described herein relate to a method for determining a root cause of an error and generating recommendations for addressing the root cause, the method including: deploying, by one or more processors of a computing device, a trained machine learning model and a trained language model in a client environment; retrieving, by the one or more processors via the trained machine learning model, log files associated with the client environment and indicative of one or more errors in the client environment; analyzing, by the one or more processors via the trained machine learning model, the log files to determine identifiers indicative of a root cause of the one or more errors in the client environment; embedding, by the one or more processors, the identifiers into an embedding space such that the embedding is indicative of at least one weighted similarity metric of the one or more errors to one or more stored historical errors; and generating, by the one or more processors and based on the embedding space, a recommendation for the one or more errors associated with the client environment via the trained language model.

In some aspects, the techniques described herein relate to a method, wherein the recommendation includes one or more remediation steps, the method further including: generating, by the one or more processors, a remediation configuration including modifications to one or more parameters of the client environment based on the generated recommendation for the one or more errors; and deploying, by the one or more processors, the remediation configuration to the client environment.

In some aspects, the techniques described herein relate to a method, further including: filtering, by the one or more processors, the log files to remove at least one of debug noise, timestamps, or routine operation logs.

In some aspects, the techniques described herein relate to a method, wherein the embedding occurs responsive to determining that the at least one weighted similarity metric of the one or more errors to the one or more stored historical errors meets a predetermined threshold value.

In some aspects, the techniques described herein relate to a method, wherein the at least one weighted similarity metric is a first weighted similarity metric and the method further includes, responsive to determining that the at least one weighted similarity metric of the one or more errors to the one or more stored historical errors does not meet the predetermined threshold value: transmitting, by the one or more processors, a query to an external machine learning model including a plurality of structured diagnostic prompts; and embedding, by the one or more processors, the identifiers into the embedding space such that the embedding is indicative of a second weighted similarity metric of the one or more errors to a response by the external machine learning model.

In some aspects, the techniques described herein relate to a method, further including, responsive to determining that the at least one weighted similarity metric of the one or more errors to the one or more stored historical errors does not meet the predetermined threshold value: scraping, by the one or more processors, a search database for one or more community validated remediation elements; and augmenting, by the one or more processors, the recommendation based on the one or more community validated remediation elements.

In some aspects, the techniques described herein relate to a method, wherein the trained machine learning model is a generalized and lightweight model for named entity recognition (GLiNER).

In some aspects, the techniques described herein relate to a system configured to determine a root cause of an error and generate recommendations for addressing the root cause, the system including: one or more processors; and computer-readable media storing machine readable instructions that, when executed, cause the one or more processors to: deploy a trained machine learning model and a trained language model in a client environment; retrieve, via the trained machine learning model, log files associated with the client environment and indicative of one or more errors in the client environment; analyze, via the trained machine learning model, the log files to determine identifiers indicative of a root cause of the one or more errors in the client environment; embed the identifiers into an embedding space such that the embedding is indicative of at least one weighted similarity metric of the one or more errors to one or more stored historical errors; and generate, based on the embedding space, a recommendation for the one or more errors associated with the client environment via the trained language model.

In some aspects, the techniques described herein relate to a system, wherein the recommendation includes one or more remediation steps and the machine readable instructions include further instructions that, when executed, cause the one or more processors to: generate a remediation configuration including modifications to one or more parameters of the client environment based on the generated recommendation for the one or more errors; and deploy the remediation configuration to the client environment.

In some aspects, the techniques described herein relate to a system, wherein the machine readable instructions include further instructions that, when executed, cause the one or more processors to: filter the log files to remove at least one of debug noise, timestamps, or routine operation logs.

In some aspects, the techniques described herein relate to a system, wherein embedding the identifiers occurs responsive to determining that the at least one weighted similarity metric of the one or more errors to the one or more stored historical errors meets a predetermined threshold value.

In some aspects, the techniques described herein relate to a system, wherein the at least one weighted similarity metric is a first weighted similarity metric and the machine readable instructions include further instructions that, when executed, cause the one or more processors to, responsive to determining that the at least one weighted similarity metric of the one or more errors to the one or more stored historical errors does not meet the predetermined threshold value: transmit a query to an external machine learning model including a plurality of structured diagnostic prompts; and embed the identifiers into the embedding space such that the embedding is indicative of a second weighted similarity metric of the one or more errors to a response by the external machine learning model.

In some aspects, the techniques described herein relate to a system, wherein the machine readable instructions include further instructions that, when executed, cause the one or more processors to, responsive to determining that the at least one weighted similarity metric of the one or more errors to the one or more stored historical errors does not meet the predetermined threshold value: scraping, by the one or more processors, a search database for one or more community validated remediation elements; and augmenting, by the one or more processors, the recommendation based on the one or more community validated remediation elements.

In some aspects, the techniques described herein relate to a system, wherein the trained machine learning model is a generalized and lightweight model for named entity recognition (GLiNER).

In some aspects, the techniques described herein relate to a tangible, non-transitory computer-readable medium storing instructions for determining a root cause of an error and generating recommendations for addressing the root cause that, when executed by one or more processors of a computing device, cause the computing device to: deploy a trained machine learning model and a trained language model in a client environment; retrieve, via the trained machine learning model, log files associated with the client environment and indicative of one or more errors in the client environment; analyze, via the trained machine learning model, the log files to determine identifiers indicative of a root cause of the one or more errors in the client environment; embed the identifiers into an embedding space such that the embedding is indicative of at least one weighted similarity metric of the one or more errors to one or more stored historical errors; and generate, based on the embedding space, a recommendation for the one or more errors associated with the client environment via the trained language model.

In some aspects, the techniques described herein relate to a non-transitory computer-readable medium, wherein the recommendation includes one or more remediation steps and the non-transitory computer-readable medium includes further instructions that, when executed by the one or more processors, cause the computing device to: generate a remediation configuration including modifications to one or more parameters of the client environment based on the generated recommendation for the one or more errors; and deploy the remediation configuration to the client environment.

In some aspects, the techniques described herein relate to a non-transitory computer-readable medium, wherein the non-transitory computer-readable medium includes further instructions that, when executed by the one or more processors, cause the computing device to: filter the log files to remove at least one of debug noise, timestamps, or routine operation logs.

In some aspects, the techniques described herein relate to a non-transitory computer-readable medium, wherein embedding the identifiers occurs responsive to determining that the at least one weighted similarity metric of the one or more errors to the one or more stored historical errors meets a predetermined threshold value.

In some aspects, the techniques described herein relate to a non-transitory computer-readable medium, wherein the at least one weighted similarity metric is a first weighted similarity metric and the non-transitory computer-readable medium includes further instructions that, when executed by the one or more processors, cause the computing device to, responsive to determining that the at least one weighted similarity metric of the one or more errors to the one or more stored historical errors does not meet the predetermined threshold value: transmit a query to an external machine learning model including a plurality of structured diagnostic prompts; and embed the identifiers into the embedding space such that the embedding is indicative of a second weighted similarity metric of the one or more errors to a response by the external machine learning model.

In some aspects, the techniques described herein relate to a non-transitory computer-readable medium, wherein the non-transitory computer-readable medium includes further instructions that, when executed by the one or more processors, cause the computing device to, responsive to determining that the at least one weighted similarity metric of the one or more errors to the one or more stored historical errors does not meet the predetermined threshold value: scrape a search database for one or more community validated remediation elements; and augment the recommendation based on the one or more community validated remediation elements.

### BRIEF DESCRIPTION OF THE DRAWINGS

FIG. 1 is a block diagram of an example system in which techniques of the present disclosure can be implemented.

FIG. 2 is a block diagram of example modules implemented in an example system, such as that of FIG. 1, for implementing the techniques as described herein.

FIG. 3 is a flow diagram of an example method for determining a root cause of an error and generating recommendations for addressing the root cause, implemented in the system of FIG. 1.

### DETAILED DESCRIPTION OF THE DRAWINGS

Generally, the systems and methods disclosed herein may include or utilize machine learning models trained to determine a root cause of an error and generate recommendations for solutions to such. In particular, a model may analyze log files in a client environment and determine the important lines and keywords needed to detect the actual root cause of an error. The model is trained using expert input on a predetermined quantity of most common errors, problems, and solutions. If the model determines, using NLP analysis of the important lines and keywords, that the error is one of the most common errors, the model presents the solution. Otherwise, a trained LLM (or SLM) determines an alternative solution recommendation.

In particular, the trained LLM and/or SLM embeds tokens representative of the error problem and similar errors into an embedding space. The trained language model weights various metrics associated with the log files, error, and/or client space and determines further recommendations based on similar problems. If the trained language model does not determine any solutions are sufficiently close to the current error and/or sufficiently likely to work, the model can query additional sources (e.g., a search query to a search engine). After the trained language model provides recommendations to a user, the user can indicate whether the solution worked or not, and the model can update based on such. If the solution did not work, the user can input what did work to further train the model. As such, the model(s) can more accurately, securely, and privately perform user acceptance testing by taking into account more client environment variables and by safely maintaining user information regarding daily behaviors and patterns. (e.g., by deploying the models in the client environment).

Moreover, by performing the techniques as described herein, computing devices are improved. Notably, the system is able to address errors more directly and with more accurate information, as it is directly gathered from the client environment, requiring fewer resources to attack multiple errors repeatedly in attempting to find a solution. Further, there is reduced latency in that required communications between a model stored on a remote server and the client device are reduced. Still further, the systems may receive feedback from the user(s) to further improve the model with additional information in instances where the model is incorrect, reducing the likelihood of a failed recommendation and/or hallucinations in the model response.

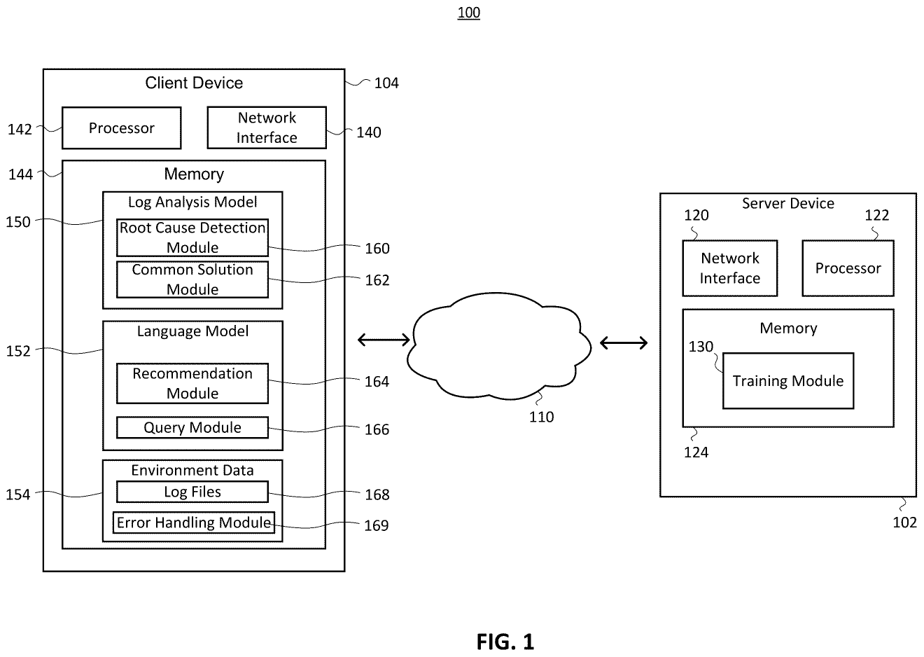

FIG. 1 illustrates an example system 100 in which the techniques disclosed herein may be implemented. The example system 100 includes a server device 102, a client device 104, and a network 110. The client device 104 in some implementations is remote from the server device 102, and communicatively coupled to the server device 102 via the network 110. It will be understood that system 100 is exemplary, and that other systems may include additional, fewer, or alternative components (e.g., training module 130 may be omitted and/or included on the client device 104). Similarly, arrangements of the components of system 100 may be modified. For example, some elements of system 100 may be combined, split apart, swapped, etc.

The network 110 may be a single communication network (e.g., the Internet), and in some implementations also includes one or more additional networks. As an example, the network 110 may include a cellular network, the Internet, and a server-side local area network (LAN). While FIG. 1 shows only a single server device 102 and client device 104, it will be understood that the system 100 may include any suitable number of similar client devices, computing devices, and/or databases operating according to the principles disclosed herein.

The client device 104 may be or include any stationary, mobile, or portable computing device with wired and/or wireless communication capability (e.g., a smartphone, a tablet computer, a laptop computer, a desktop computer, a smart wearable device such as smart glasses or a smart watch, etc.). In the example implementation of FIG. 1, the client device 104 includes a network interface 140, a processor 142, and a memory 144. The processor 142 may be a single processor (e.g., a central processing unit (CPU)), or may include a set of processors (e.g., multiple CPUs, or one or more CPUs and one or more graphics processing units (GPUs)).

The memory 144 includes one or more computer-readable, non-transitory storage units or devices, which may include persistent (e.g., hard disk) and/or non-persistent memory components. The memory 144 stores instructions that are executable by the processor 142 to perform various operations, including the instructions of various software applications and the data generated and/or used by such applications. In the example implementation of FIG. 1, the memory 144 stores at least a log analysis model 150, a language model 152, and/or environment data 154.

In some implementations, the log analysis model 150 includes a root cause detection module 160 and a common solution module 162. Depending on the implementation, the log analysis model 150 is a trained machine learning model (e.g., as described herein), and is configured to analyze an error occurring in a client environment. In particular, the log analysis model 150 may analyze the error using natural language processing (NLP) techniques via the root cause detection module 160. The log analysis model 150 may determine whether the detected error in the client environment matches any one of a number of common errors (e.g., the 10 most common errors, 100 most common errors, 500 most common errors, etc.) as stored in a database (not shown) (e.g., input by subject matter experts, pulled via search query and an API, determined using historical errors, etc.). If so, then, in some implementations, the log analysis model 150, via the common solution module 162, determines whether any solutions exist to the common error and presents such to a user.

In some implementations, the language model 152 includes a recommendation module 164 and a query module 166. The language model 152 may tokenize and embed words of the error into an embedding space (e.g., as described herein), weight various metrics associated with the log files and/or errors, and determine whether a solution to the error exists (e.g., within a stored database). If so, the recommendation module 164 may generate and/or provide a recommendation to a user. Otherwise, the query module 166 may generate and transmit a search query (e.g., via a search engine, a database search, etc.) to determine whether the error is similar to any of the results.

In some implementations, the environment data 154 includes log files 168 and an error handling module 169. The log analysis model 150 and/or the language model 152 may analyze the environment data 154 such that the model(s) analyze the log files 168 and/or any output of the error handling module 169.

The network interface 140 includes hardware, firmware, and/or software configured to enable the client device 104 to exchange electronic data with the server device 102 via the network 110. For example, the network interface 140 may include a cellular communication transceiver, a Wi-Fi transceiver, and/or transceivers for one or more other wired and/or wireless communication technologies.

While FIG. 1 shows client device 104 as a single component communicating directly (i.e., via network 110) with the server device 102, in some implementations the subcomponents of client device 104 shown in FIG. 1 are instead divided among two or more user-side devices.

The server device 102 includes a network interface 120, a processor 122, and memory 124. The network interface 120 includes hardware, firmware, and/or software configured to enable the server device 102 to exchange electronic data with the client device 104 and other, similar client devices via the network 110. For example, the network interface 120 may include a wired or wireless router and a modem. The processor 122 may be a single processor, may include two or more processors, etc. The server device 102 may include one or more servers, for example, which may reside at a single location or multiple locations.

The memory 124 is a computer-readable, non-transitory storage unit or device, or collection of units/devices that may include persistent and/or non-persistent memory components. The memory 124 stores the instructions of a training module 130, which may be executed by the processor 122.

In some implementations and/or scenarios, the server device 102 (or another computing system not shown in FIG. 1) trains the models deployed on the client device 104 (e.g., the log analysis model 150 and/or the language model 152). In particular, the training module 130 may train the models using techniques for training small language models (SLMs), large language models (LLM), generative AI models, etc.

In some implementations, the modules and/or models may be or include a generative AI model, and may have been trained by server device 102 or another computing system using supervised or semi-supervised learning techniques, using training data of the appropriate modality (e.g., text data). Such generative AI models may be general-purpose models (e.g., trained on a wide array of publicly available datasets such as web pages, documents, etc., available via the Internet) or may be a domain-specific model (e.g., trained or finetuned on custom and/or proprietary datasets, such as documents/data available via one or more intranets). In some implementations, the generative AI models have parameters and/or metrics tuned, via the training process, specifically for high performance in the context of generating text regarding computing environment errors and/or solutions to such.

In particular, in some implementations, the log analysis model 150 and/or language model 152 may be a fine-tuned generative model, such as a generalist and lightweight model for named entity recognition (GLiNER model), trained via supervised learning on a specialized corpus of annotated failure logs. In further such implementations, the training data for the log analysis model 150 and/or language model 152 may include numerous examples of log file excerpts where technical entities are explicitly labeled. For example, strings corresponding to installer error codes like “MSI Error 1603,” file paths such as “C:\Windows\System32\kernel32.dll,” and registry keys like “HKLM\Software\Policies” are identified and tagged in the error data. The training module 130 may train the log analysis model 150 and/or language model 152 using training objective(s) to minimize a cross-entropy loss function, thereby learning to accurately identify and extract spans of text that represent the domain-specific entities from new, unseen log files. The process may enable the model to perform highly accurate, context-aware named entity recognition without a predefined schema.

In particular, the training module 130 may train the log analysis model 150 and/or language model 152 using bi-directional encoder-only pre-trained language model(s). As such, entity labels and input sequences may be concatenated and passed through the encoder model(s). In some implementations, the boundary for each entity type may be defined by an entity token (e.g., an [ENT] token) representative of a corresponding entity label. The entity token(s) may then be passed through a two-layer feedforward network for further refinement. The input sequence tokens may be combined to form spans, subwords, etc. and then concatenated into a D-dimensional vector.

By utilizing a fine-tuned named entity recognition (NER) model, such as a GLiNER model, the instant techniques may address critical limitations of traditional (e.g., BERT-like and/or encoder-only) NER models. Notably, traditional models may only process predefined set(s) of discrete entities and lack zero-shot generalization capabilities outside the entity types of the corresponding training sets. Moreover, a fine-tuned NER model may maintain the cost and computational savings (e.g., due to the small size of encoder-only models) compared to decoder-only models while adding zero-shot capabilities.

In further implementations, the training module 130 may train the log analysis model 150 and/or language model 152 using a reinforcement learning component. After an initial supervised fine-tuning phase, the training module 130 may further refine the log analysis model 150 and/or language model 152 using feedback from human operators or automated testing systems to reinforce the training. For example, when the recommendation module 164 generates a remediation step based on the model's analysis, the success or failure of that step is recorded. A successful remediation provides a positive reward signal, while a failed one provides a negative signal. The training module 130 may use the reward signals to update the parameters for the log analysis model 150 and/or language model 152, such as the weights in the corresponding neural network (e.g., using algorithms like proximal policy optimization (PPO)), thus improving the ability of the log analysis model 150 and/or language model 152 to extract entities that lead to actionable and correct solutions over time.

In further implementations, the log analysis model 150 and/or language model 152 may be trained as a mixture-of-experts (MoE) model. In such a configuration, different “expert” sub-models are specialized for distinct types of errors or application contexts. For example, one expert sub-model might be trained extensively on logs and solutions related to sequencing failures for a first application, while another is trained on issues related to packaging conflicts for a second application. A gating network may be trained to learn to route an incoming failure log analysis from the log analysis model 150 to the most appropriate expert sub-model. This architecture enables the system to develop deep, specialized knowledge in various sub-domains, potentially leading to more accurate and nuanced recommendations than a single monolithic model.

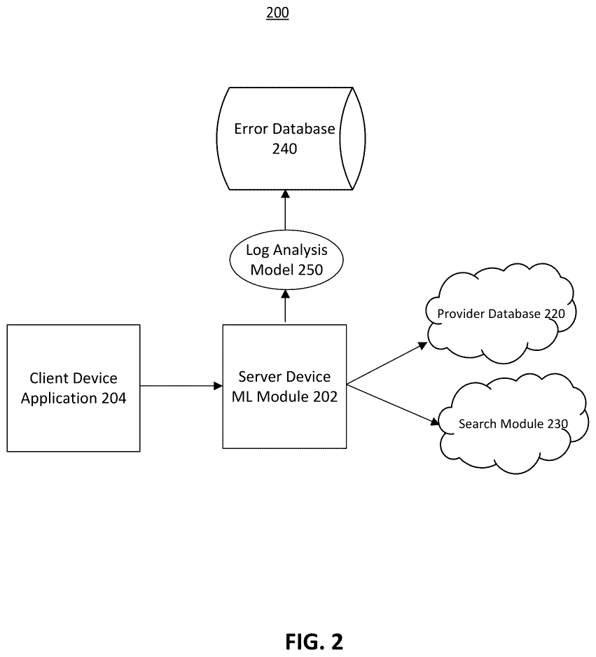

Furthermore, in yet another implementation, the query module 166 may employ and/or be trained as a generative adversarial network (GAN) for query generation. A generator network for the query module may be trained to produce structured diagnostic prompts optimized for external LLMs, while a discriminator network may be trained to distinguish between effective and ineffective prompts based on historical query success data. The generator and discriminator are trained in competition: the generator attempts to create prompts that the discriminator cannot identify as sub-optimal. The adversarial process may refine the ability for the query module 166 to craft queries that are most likely to elicit useful and accurate information from external sources like a provider database and/or a search module (e.g., as described below with regard to FIG. 2), thereby improving the performance of the fallback path.

FIG. 2 depicts a block diagram of a subsystem 200 including a series of modules implementing models in a system (e.g., the system 100 of FIG. 1). Depending on the implementations, the modules may be, be components of, or include elements of FIG. 1. For example, the client device application 204 may be implemented on a client device 104 of FIG. 1 (e.g., via the memory 144), the server device ML module 202 may be implemented on a server device 102 of FIG. 1 (e.g., via the memory 124), the log analysis model 250 may be or include the log analysis model 150 and/or the language model 152 of FIG. 1, etc. It will be understood that embodiments including additional, alternate, or fewer elements are contemplated, and thus the described embodiments should not be considered as exclusive.

The client device application 204 may receive an indication of and/or otherwise detect an occurrence of an error, as described herein. Depending on the implementation, the client device application 204 may determine that an error occurs as part of an internal error-handling process (e.g., of the client device, of the client device application 204, of a communicatively coupled device, of another application running on the client device, etc.). In further implementations, the client device application 204 may determine that an error occurs responsive to an indication from the user (e.g., via an interaction event with a prompt to report an error, via a user command input through a command shell, via the user initiating the client device application 204, etc.). Similarly, the client device application 204 may determine that an error occurs responsive to an indication from a communicatively coupled device (e.g., a mobile device, an accessory associated with the client device, etc.).

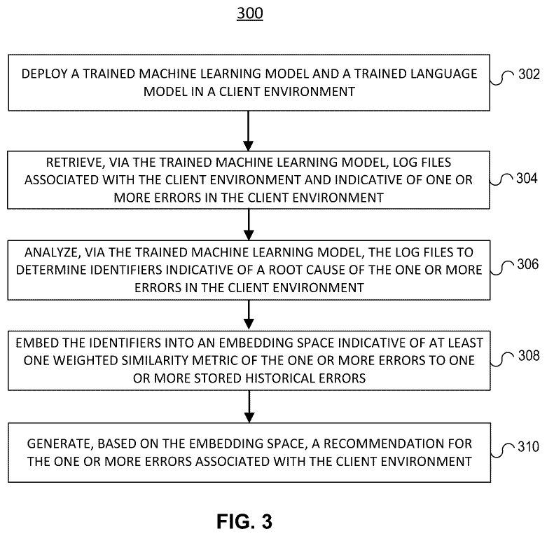

After receiving the indication of and/or otherwise detecting the occurrence of the error, the client device application 204 may transmit and/or cause the client device to transmit, an indication of the error to the server device ML module 202. The server device ML module 202 may then orchestrate the workflow of the error determination as described herein with regard to FIGS. 1 and 3. Depending on the implementation, the indication of the error may include log files and data associated with the error(s) (e.g., activity logs, failure logs, security logs, environment data, etc.). Responsive to receiving the indication and/or responsive to receiving particular data, the server device ML module 202 may call and/or otherwise instantiate one or more log analysis model(s) 250.

Depending on the implementation, the log analysis model(s) 250 may include multiple submodels and/or model functionalities for analyzing the received information from the client device application 204. For example, depending on the implementation, the log analysis model(s) 250 may include a filter model, a keyword extraction model, etc. In some such implementations, the filter model and/or functionality may use various filtering techniques, such as rule-based pattern matching, heuristics, etc., to identify and isolate error-related content from verbose process streams, removing debug information, timestamps, routine operational logs, and/or other such data that doesn't contribute to failure diagnosis. Depending on the implementation, the server device ML module 202 may call the filter model and/or the log analysis model(s) 250 may engage a filtering functionality responsive to detecting that additional unnecessary data is present, automatically, responsive to a user indication, etc.

In further implementations, the log analysis model(s) 250 may include a keyword extraction model and/or functionality may utilize various natural language processing techniques, such as named entity recognition techniques (e.g., generalized named entity recognition), large language model analysis, etc. to analyze keywords in the data. In some implementations, the keyword extraction model includes a span-based extraction architecture that identifies technical entities (e.g., error codes, API calls, file paths, registry keys, DLL names, etc.) without requiring entity-type-specific training data. In further implementations, the log analysis model(s) may be fine-tuned on annotated test failure logs to recognize application packaging-specific terminology for determining errors associated with such.

In some implementations, the log analysis model(s) 250 may be trained on annotated failure logs from specific domains, such as enterprise application packaging. The training data may include labeled entities such as installer error codes (e.g., MSI, App-V, MSIX), file paths, registry keys, DLLs, API calls, operating system configuration references, and/or deployment context. The log analysis model(s) 250 may be configured with weighted importance scoring to prioritize domain-specific terminology and adaptive thresholding to filter low-confidence entities.

In further implementations, a preprocessing model (e.g., as part of the log analysis model(s) 250 and/or as a separate model called by the server device ML module 202) performs rule-based and/or heuristic filtering to remove extraneous information like debug noise and timestamps from log files, isolating segments relevant to a failure. In some such implementations, the machine learning model then extracts technical entities and associated context from the filtered log segments. The server device ML module 202 and/or another module may then extract entities, and may score the corresponding context. The server device ML module 202 may use the scored context and/or the extracted entities to generate weighted vector representations for storage and retrieval in a vector database.

The server device ML module 202 and/or the log analysis model(s) 250 may construct and/or otherwise generate queries (e.g., database queries, vector database queries, etc.) to the error database 240 using the extracted terms. In some implementations, responsive to receiving a response to the generated queries returning matching historical failures, the server device ML module 202 may use the LLM to synthesize a technical explanation by comparing the current failure signature with resolved cases and steps taken to rectify and/or mitigate such.

In some implementations, the error database 240 may store both the raw error text and contextual attributes (e.g., application metadata, operating system details, testing configurations, etc.) of various historical errors. The server device ML module 202 and/or log analysis model(s) 250 may perform a weighted search to identify historical failures that are similar to a current failure. In some such implementations, the server device ML module 202 and/or log analysis model(s) 250 may perform the weighted search with boosting applied based on entity relevance scores and/or failure-context similarity. In some implementations, the results of the comparison may be provided to a large language model (LLM) to synthesize a technical explanation and recommend one or more remediation steps.

In some implementations, the system (e.g., the client device 104 of system 100) may further include a user interface that allows an operator to select and apply a recommended fix and/or remediation step as generated by a LLM (e.g., part of the log analysis model(s) 250 and/or another model). Depending on the implementation, by applying a fix, the system can trigger a corresponding workflow in a packaging system, which may include actions such as injecting transformations, modifying deployment flags, or adjusting sequencing parameters (e.g., for MSIX or App-V packages).

In some implementations, the server device ML module 202 may activate and/or utilize a fallback mechanism responsive to being unable to find a matching failure signature in the error database 240. For example, if calculated knowledge base similarity scores fall below a threshold value, the server device ML module 202 may transmit the query and/or generate a new query for external models (e.g., in a provider database 220). Additionally or alternatively, the server device ML module 202 may search and/or scrape a search module 230 (e.g., a search database, technical forum, documentation, etc.) for particular error signatures indicative of matching failure(s). In some such implementations, the server device ML module 202 augments, modifies, and/or otherwise corrects a received output from the provider database with information from the search module 230 to reflect community-validated solutions. In some implementations, the server device ML module 202 may additionally train the log analysis model(s) with the output of the fallback mechanism and/or update the error database 240 based on the determined and/or provided mitigation or solution.

The instant techniques may differ from and offer improvements over traditional systems. For example, traditional log analysis systems may rely purely on keyword matching or generic anomaly detection. As such, traditional systems may struggle with domain-specific terminology in application packaging and may be unable to determine different root causes associated with similar error messages depending on application context. The instant techniques may utilize context-aware keyword extraction (e.g., using generalized name entity recognition (GLiNER)) to determine the context associated with an error report rather than relying solely on natural language processing of keywords. Further, by using additional data (e.g., the environment data 154 of FIG. 1, such as application metadata, operation system environment information, test configuration(s), etc.), the instant techniques may more accurately determine context and better diagnose and/or mitigate error root causes.

Moreover, the instant techniques may address the cold-start problem inherent to the field of computing error diagnostics and/or mitigation. Without sufficient historical data, traditional systems struggle to provide useful diagnostics, leading to error problems without sufficient ability for users to respond. By utilizing the fallback mechanism to query additional models and real-time searches via a search module, the instant techniques may generate an improved response and/or solution. Similarly, by training the model and/or updating the database based on the generated information, the knowledge base may be continuously improved, enabling a self-improving system to automatically generate and log future knowledge, offering an improvement over static rule-based diagnostic systems.

FIG. 3 is a flow diagram of an example method 300 for determining a root cause of an error and generating recommendations for addressing the root cause. The method 300 may be implemented as instructions stored on one or more non-transitory, computer-readable media (e.g., memory 144) and executed by one or more processors in one or more computing devices. For example, the method 300 may be implemented by the processor 142 of the client device 104 in FIG. 1, when executing instructions of the log analysis model 150 and/or language model 152. It will be understood that additional, fewer, and/or alternate components may be used to implement the example method 300.

At block 302, the client device 104 and/or a communicatively coupled server device (e.g., the server device 102) deploys a trained machine learning model (e.g., log analysis model 150) and a trained language model (e.g., language model 152). In some implementations, the trained machine learning model is trained using a predetermined set of common errors (e.g., the 50 most common errors, the 100 most common errors, the 500 most common errors, etc.) and/or expert responses to the predetermined set of errors. Depending on the implementation, the trained machine learning model may be or include a generalized and lightweight model for named entity recognition (GLiNER model).

In some implementations, the client device 104 and/or the server device 102 trains the trained machine learning model by adding new data (e.g., via a subject matter expert feeding in and/or approving data) to build a knowledge base. As such, after determining a recommendation for an error, the trained machine learning model may be further trained using the determined output if verified (e.g., by a user verification, by an expert verification, etc.).

At block 304, the client device 104 and/or the server device 102 retrieves, via the trained machine learning model, log files that are (i) associated with the client environment and/or (ii) indicative of one or more errors in the client environment. In some implementations, the client device 104 and/or the server device 102 filters the log files to remove at least one of debug noise, timestamps, routine operation logs, and/or any other such log files not related to the one or more errors.

At block 306, the client device 104 and/or the server device 102 analyzes, via the trained machine learning model, the log files to determine identifiers indicative of a root cause of the one or more errors in the client environment. In some implementations, the client device 104 and/or the server device 102 determines the identifiers using one or more determined important lines and/or keywords. Depending on the implementation, the trained machine learning model is trained with labeled data (e.g., important lines and/or keywords and indications that such are designated as important) to determine important lines and/or keywords from the remainder of the error(s) in question. In some implementations, the trained machine learning model analyzes the log files using natural language processing (NLP) techniques.

At block 308, the client device 104 and/or the server device 102 embeds the identifiers into an embedding space such that the embedding is indicative of at least one weighted similarity metric of the one or more errors to one or more stored historical errors. Depending on the implementation, the historical errors are or include a predetermined set of errors (e.g., identified by one or more experts as common errors). In some implementations, the historical errors are stored in a historical error database. In further implementations, the trained machine learning model is trained using the predetermined set of errors.

In some implementations, the embedded identifiers are matched via fuzzy matching using vectors (e.g., with NLP models). As such, the trained machine learning model may determine that the one or more errors are similar (e.g., meet a predetermined similarity threshold) even if the one or more errors are not an exact match. In further implementations, the trained language model may embed the identifiers into an embedding space for analysis. In still further implementations, another module or model may embed the identifiers for analysis by the trained machine learning model and/or trained language model.

In further implementations, the embedding occurs responsive to determining that the at least one weighted similarity metric of the one or more errors to the one or more stored historical errors meets a predetermined threshold value. In some such implementations, the client device 104 and/or the server device 102, responsive to determining that the weighted similarity metric does not meeting the predetermined threshold value, may transmit a query to an external machine learning model (e.g., including structured diagnostic prompts). The client device 104 and/or the server device 102 may then embed the identifiers into the embedding space such that the embedding is indicative of a second weighted similarity metric of the one or more errors to a response by the external machine learning model. In further implementations, the client device 104 and/or the server device 102 further scrapes a search database for one or more community validated remediation elements and/or augments the recommendation based on the one or more community validated remediation elements.

At block 310, the client device 104 and/or the server device 102 generates, based on the embedding space, a recommendation for the one or more errors associated with the client environment. In some implementations, the client device 104 and/or the server device 102 generates the recommendation responsive to determining whether the one or more errors meet a predetermined similarity threshold for at least one of the errors stored in the historical error database. In some such implementations, when the one or more errors meet the similarity threshold, the client device 104 and/or the server device 102 provides a recommendation associated with the corresponding error(s). If the one or more errors do not meet the predetermined similarity threshold, then the client device 104 and/or the server device 102 instead analyzes the one or more errors using the trained language model (e.g., a large language model (LLM), small language model (SLM), etc.). In further implementations, the client device 104 and/or the server device 102 generates the recommendation using a plurality of trained machine learning models rather than a single trained machine learning model. In some such implementations, the client device 104 and/or the server device 102 may use a primary machine learning model and a number of supplemental machine learning models (e.g., a machine learning model trained to analyze the one or more errors, a machine learning model trained to determine whether the one or more errors meet the predetermined similarity threshold, a machine learning model trained to generate the recommendation, etc.). In still further implementations, the client device 104 and/or the server device 102 uses at least some redundant machine learning models to generate a plurality of potential recommendations and determines which recommendation to provide to the user (e.g., based on past preference data, based on number of separate models generating similar recommendations, etc.).

In further implementations, the trained language model similarly embeds tokens representative of the error and/or similar errors into an embedding space. In some implementations, the trained language model performs such in place of and/or in addition to block 308 as described above. The trained language model may then weight metrics associated with log files, errors, and/or the environment of the client device to determine further recommendations based on similar errors. If the trained language model cannot or does not determine that any solutions are to errors that meet the predetermined similarity threshold, the trained language model can generate a search query to additional sources (e.g., a search engine) or return an indication that no solution could be found.

In some implementations, the tokens embedded into the embedding space and/or information queried includes a device manufacturer, a software version, an application name, an error code number, and/or any other such information. As such, information closer to the instant error(s) may be weighted to be embedded closer (e.g., have a stronger correlation to) the error(s). For example, an error from a device from the same manufacturer and running the same version of the operating system may be weighted more heavily than an error from another device that is worded more closely. In some implementations, the weights are able to be adjusted during analysis, during training, etc. by an expert and/or a user.

In some implementations, the client device 104 and/or the server device 102 prompts the user as to whether the proposed recommendation worked. If so, then the trained machine learning model and/or trained language model can update and/or be retrained based on such. Otherwise, the client device 104 and/or the server device 102 can prompt the user to input the solution to use in training the model(s).

In some implementations, the recommendation includes one or more remediation steps that the system can automatically, responsive to a user prompt, and/or instruct a user to undertake to implement a solution to the detected one or more errors. In some such implementations, the client device 104 and/or the server device 102 may generate a remediation configuration including modifications to one or more parameters of the client environment based on the generated recommendation for the one or more errors. The client device 104 and/or the server device 102 may then deploy the remediation configuration to the client environment (e.g., automatically, responsive to a user indication, etc.). As such, the methods detailed herein may modify actual operation of a communicatively coupled device and/or of a device on which the instructions are deployed.

It will be understood that, although the above steps are described as being performed by the client device 104, a cloud server at the network (e.g., network 110), and/or a server device 102 may perform some or all of the above steps. In some implementations, any analysis of and/or functions regarding data with user information may be performed at the client device 104 and/or neutral cloud device at the network 110, while analysis that does not rely on such data may be performed at the server device to preserve privacy and/or security.

Artificial intelligence (AI) is a segment of computer science that focuses on the creation of models that can perform tasks with little to no human intervention. Artificial intelligence systems can utilize, for example, machine learning and computer vision. Machine learning, and its subsets, such as deep learning, focus on developing models that can infer outputs from data. The outputs can include, for example, predictions and/or classifications. Computer vision focuses on analyzing and interpreting images and videos. Artificial intelligence systems can include generative models that generate new content in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

In some implementations, the client device 104 may use one or more the machine learning models noted above to perform any one or more of the operations discussed herein in connection with machine learning.

Although the foregoing text sets forth a detailed description of numerous different aspects and implementations of the invention, it should be understood that the scope of the patent is defined by the words of the claims set forth at the end of this patent. The detailed description is to be construed as exemplary only.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present) and B is true (or present), and both A and B are true (or present).

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations.

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes, and variations, which will be apparent to those skilled in the art, may be made in the arrangement, operation and details of the method and apparatus disclosed in the present disclosure without departing from the spirit and scope defined in the appended claims.

What is claimed is:

1. A method for determining a root cause of an error and generating recommendations for addressing the root cause, the method comprising:
deploying, by one or more processors of a computing device, a trained machine learning model and a trained language model in a client environment;
retrieving, by the one or more processors via the trained machine learning model, log files associated with the client environment and indicative of one or more errors in the client environment;
analyzing, by the one or more processors via the trained machine learning model, the log files to determine identifiers indicative of a root cause of the one or more errors in the client environment;
embedding, by the one or more processors, the identifiers into an embedding space such that the embedding is indicative of at least one weighted similarity metric of the one or more errors to one or more stored historical errors; and
generating, by the one or more processors and based on the embedding space, a recommendation for the one or more errors associated with the client environment via the trained language model.

2. The method of claim 1, wherein the recommendation includes one or more remediation steps, the method further comprising:
generating, by the one or more processors, a remediation configuration including modifications to one or more parameters of the client environment based on the generated recommendation for the one or more errors; and
deploying, by the one or more processors, the remediation configuration to the client environment.

3. The method of claim 1, further comprising:
filtering, by the one or more processors, the log files to remove at least one of debug noise, timestamps, or routine operation logs.

4. The method of claim 1, wherein the embedding occurs responsive to determining that the at least one weighted similarity metric of the one or more errors to the one or more stored historical errors meets a predetermined threshold value.

5. The method of claim 4, wherein the at least one weighted similarity metric is a first weighted similarity metric and the method further comprises, responsive to determining that the first weighted similarity metric of the one or more errors to the one or more stored historical errors does not meet the predetermined threshold value:
transmitting, by the one or more processors, a query to an external machine learning model including a plurality of structured diagnostic prompts; and
embedding, by the one or more processors, the identifiers into the embedding space such that the embedding is indicative of a second weighted similarity metric of the one or more errors to a response by the external machine learning model.

6. The method of claim 5, further comprising, responsive to determining that the at least one weighted similarity metric of the one or more errors to the one or more stored historical errors does not meet the predetermined threshold value:
scraping, by the one or more processors, a search database for one or more community validated remediation elements; and
augmenting, by the one or more processors, the recommendation based on the one or more community validated remediation elements.

7. The method of claim 1, wherein the trained machine learning model is a generalized and lightweight model for named entity recognition (GLiNER).

8. A system configured to determine a root cause of an error and generate recommendations for addressing the root cause, the system comprising:
one or more processors; and
computer-readable media storing machine readable instructions that, when executed, cause the one or more processors to:
deploy a trained machine learning model and a trained language model in a client environment;
retrieve, via the trained machine learning model, log files associated with the client environment and indicative of one or more errors in the client environment;
analyze, via the trained machine learning model, the log files to determine identifiers indicative of a root cause of the one or more errors in the client environment;
embed the identifiers into an embedding space such that the embedding is indicative of at least one weighted similarity metric of the one or more errors to one or more stored historical errors; and
generate, based on the embedding space, a recommendation for the one or more errors associated with the client environment via the trained language model.

9. The system of claim 8, wherein the recommendation includes one or more remediation steps and the machine readable instructions include further instructions that, when executed, cause the one or more processors to:
generate a remediation configuration including modifications to one or more parameters of the client environment based on the generated recommendation for the one or more errors; and
deploy the remediation configuration to the client environment.

10. The system of claim 8, wherein the machine readable instructions include further instructions that, when executed, cause the one or more processors to:
filter the log files to remove at least one of debug noise, timestamps, or routine operation logs.

11. The system of claim 8, wherein embedding the identifiers occurs responsive to determining that the at least one weighted similarity metric of the one or more errors to the one or more stored historical errors meets a predetermined threshold value.

12. The system of claim 11, wherein the at least one weighted similarity metric is a first weighted similarity metric and the machine readable instructions include further instructions that, when executed, cause the one or more processors to, responsive to determining that the first weighted similarity metric of the one or more errors to the one or more stored historical errors does not meet the predetermined threshold value:
transmit a query to an external machine learning model including a plurality of structured diagnostic prompts; and
embed the identifiers into the embedding space such that the embedding is indicative of a second weighted similarity metric of the one or more errors to a response by the external machine learning model.

13. The system of claim 12, wherein the machine readable instructions include further instructions that, when executed, cause the one or more processors to, responsive to determining that the at least one weighted similarity metric of the one or more errors to the one or more stored historical errors does not meet the predetermined threshold value:
scraping, by the one or more processors, a search database for one or more community validated remediation elements; and
augmenting, by the one or more processors, the recommendation based on the one or more community validated remediation elements.

14. The system of claim 8, wherein the trained machine learning model is a generalized and lightweight model for named entity recognition (GLiNER).

15. A tangible, non-transitory computer-readable medium storing instructions for determining a root cause of an error and generating recommendations for addressing the root cause that, when executed by one or more processors of a computing device, cause the computing device to:
deploy a trained machine learning model and a trained language model in a client environment;
retrieve, via the trained machine learning model, log files associated with the client environment and indicative of one or more errors in the client environment;
analyze, via the trained machine learning model, the log files to determine identifiers indicative of a root cause of the one or more errors in the client environment;
embed the identifiers into an embedding space such that the embedding is indicative of at least one weighted similarity metric of the one or more errors to one or more stored historical errors; and
generate, based on the embedding space, a recommendation for the one or more errors associated with the client environment via the trained language model.

16. The non-transitory computer-readable medium of claim 15, wherein the recommendation includes one or more remediation steps and the non-transitory computer-readable medium includes further instructions that, when executed by the one or more processors, cause the computing device to:
generate a remediation configuration including modifications to one or more parameters of the client environment based on the generated recommendation for the one or more errors; and
deploy the remediation configuration to the client environment.

17. The non-transitory computer-readable medium of claim 15, wherein the non-transitory computer-readable medium includes further instructions that, when executed by the one or more processors, cause the computing device to:
filter the log files to remove at least one of debug noise, timestamps, or routine operation logs.

18. The non-transitory computer-readable medium of claim 15, wherein embedding the identifiers occurs responsive to determining that the at least one weighted similarity metric of the one or more errors to the one or more stored historical errors meets a predetermined threshold value.

19. The non-transitory computer-readable medium of claim 18, wherein the at least one weighted similarity metric is a first weighted similarity metric and the non-transitory computer-readable medium includes further instructions that, when executed by the one or more processors, cause the computing device to, responsive to determining that the first weighted similarity metric of the one or more errors to the one or more stored historical errors does not meet the predetermined threshold value:
transmit a query to an external machine learning model including a plurality of structured diagnostic prompts; and
embed the identifiers into the embedding space such that the embedding is indicative of a second weighted similarity metric of the one or more errors to a response by the external machine learning model.

20. The non-transitory computer-readable medium of claim 19, wherein the non-transitory computer-readable medium includes further instructions that, when executed by the one or more processors, cause the computing device to, responsive to determining that the at least one weighted similarity metric of the one or more errors to the one or more stored historical errors does not meet the predetermined threshold value:
scrape a search database for one or more community validated remediation elements; and
augment the recommendation based on the one or more community validated remediation elements.
